(19) United States
(12) Patent Application Publication
(10) Pub. No.: US 2005/0196066 A1
(43) Pub. Date: Sep. 8, 2005

(54) METHOD AND APPARATUS FOR REMOVING BLOCKING ARTIFACTS OF VIDEO PICTURE VIA LOOP FILTERING USING PERCEPTUAL THRESHOLDS

(76) Inventors: Changsung Kim, Taipei City (TW); Hsuan-Huei SHIH, Taipei City (TW); Chung-Chieh KUO, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/710,471

(22) Filed: Jul. 14, 2004

(30) Foreign Application Priority Data
Mar. 5, 2004 (TW) 093105970

(51) Int. Cl. G06K 9/36; G06K 9/40

(52) U.S. Cl. 382/268; 382/261; 382/232

(57) ABSTRACT

A video processing method and a related device for processing blocking artifacts between two blocks within a video picture uses loop filtering and compares two boundary edge pixels at both sides of a boundary between two blocks according to at least one perceptual threshold to determine if pixel values of the two boundary edge pixels should be adjusted to decrease the difference corresponding to the pixel values of the two boundary edge pixels.

### BACKGROUND OF INVENTION

1. Field of the Invention

The present invention relates to a method and an apparatus for removing blocking artifact of a video picture, and more particularly, to a method and an apparatus for removing blocking artifacts of a video picture via loop filtering using perceptual thresholds.

2. Description of the Prior Art

Currently, as defined in most video encoding specifications, pixel data of a video picture is usually encoded in units of blocks (e.g. each block including 4 by 4 pixels). A quantization operation of each block is required for increasing the compression rate of the pixel data. As a result, after being decoded, the block-based video picture has blocking artifacts, which are discontinuity effects around boundaries between the blocks. In order to decrease the severity of the blocking artifacts to improve the quality of the block-based video picture, the H.264 specification, which is a newly introduced video encoding specification, utilizes loop filtering for processing the blocking artifacts. Please refer to the H.264 specification for more information.

When implementing, a loop filter is installed within an encoding loop or a decoding loop of a video processing system to perform the above-mentioned loop filtering. The processing efficiency of the loop filter is better than that of a post filter installed outside an encoding loop or a decoding loop. In addition, it is unnecessary to install a buffer for the loop filter as required for the post filter. FIG. 1 illustrates a combination of video processing systems 110 and 130 including loop filters, respectively, and a transmission/storage media 120. The video processing system 110 is an encoding loop 110 for encoding video data inputted from an input end 111. The transmission/storage media 120 is used for transmitting or storing encoded video data generated by the encoding loop 110. The video processing system 130 is a decoding loop 130 for decoding the encoded video data inputted from the transmission/storage media 120 and outputting decoded video data at an output end 133. Please note, the transmission/storage media 120 can be a transmission channel such as the internet. In addition, the transmission/storage media 120 can be a storage device such as a CD drive or a DVD drive.

The encoding loop 110 includes an encoding unit 112, a reconstruction unit 114, and a loop filter 116. The decoding loop 130 includes a decoding unit 132 and a loop filter 136. As needed for video processing complying with the MPEG specification, data of predictive frames (P frames) including partial video information should be compared with data of intra frames (I frames) including full video information by the encoding loop 110 so that the P frames can be encoded. The loop filter 116 performs the loop filtering while the encoding loop 110 performs the encoding. As a result, the processing efficiency of the loop filter 116 is better than that of the post filter. Similarly, data of the P frames should be compared with data of the I frames by the decoding loop 130 so that the P frames can be decoded. In this case, the loop filter 136 performs the loop filtering while the decoding loop 130 performs the decoding. As a result, the processing efficiency of the loop filter 136 is better than that of the post filter.

Although the H.264 specification has the advantage of the loop filtering instead of post filtering, complexity of loop filtering calculations becomes a bottleneck for processing speed. For example, within a decoder complying with the H.264 specification, the loading of a loop filter for removing blocking artifacts is 33% of the total loading of the decoder.

### SUMMARY OF INVENTION

It is therefore an objective of the present invention to provide a method and an apparatus for removing blocking artifacts of a video picture via loop filtering using perceptual thresholds to solve the above-mentioned problem.

The present invention provides a video processing method for processing blocking artifacts between two blocks within a video picture. The video processing method includes: storing pixel values corresponding to the two blocks; and comparing two boundary edge pixels adjacent to a boundary between the two blocks according to a first threshold to determine if the pixel values of the two boundary edge pixels should be adjusted, if a difference corresponding to the pixel values of the two boundary edge pixels complies with the first threshold, adjusting the pixel values of the two boundary edge pixels to decrease the difference.

Accordingly, the present invention further provides a loop filter of a video processing system for processing blocking artifacts between two blocks within a video picture. The loop filter includes: a storage unit for storing pixel values corresponding to the two blocks; a comparison unit electrically connected to the storage unit for comparing two boundary edge pixels adjacent to a boundary between the two blocks according to a first threshold to determine if the pixel values of the two boundary edge pixels should be adjusted, if a difference corresponding to the pixel values of the two boundary edge pixels complies with the first threshold, the comparison unit determining that the pixel values of the two boundary edge pixels should be adjusted to decrease the difference; and an arithmetic unit electrically connected to the comparison unit and the storage unit for adjusting the pixel values of the two boundary edge pixels.

It is an advantage of the present invention that the present invention method and device process the blocking artifacts of the video picture by loop filtering so that the present invention method and device have better processing efficiency in contrast to post filtering methods and devices.

It is another advantage of the present invention that the present invention method and device use perceptual thresholds to determine if the pixel values of the two boundary edge pixels should be adjusted so that a fast determination for ignoring blocking artifacts that are not easy to identify by the human eye is available. As a result, the early termination of processing according to the fast determination enhances the processing efficiency of the video picture.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a combination of video processing systems and a transmission/storage media according to the prior art.

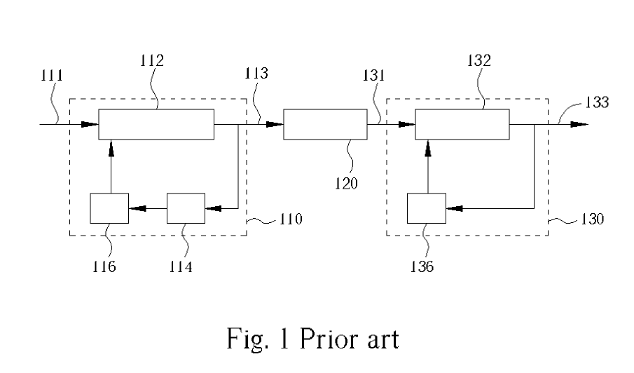

FIG. 2 is a flowchart of a video processing method according to the present invention.

FIG. 3 is a flowchart of the intra filtering process of the video processing method shown in FIG. 2.

FIG. 4 is a flowchart of the inter filtering process of the video processing method shown in FIG. 2.

FIG. 5 is a diagram of related blocks processed by the video processing method shown in FIG. 2.

FIG. 6 is a pixel sequence diagram with the pixels processed by the video processing method shown in FIG. 2.

FIG. 7 is a diagram of the pixel values processed by the video processing method shown in FIG. 2.

FIG. 8 is a lookup table of the boundary strength used in the inter filtering process shown in FIG. 4.

FIG. 9 is a block diagram of a perceptual loop filter according to the present invention.

FIG. 10 is a block diagram of a video encoder utilizing the perceptual loop filter shown in FIG. 9.

FIG. 11 is a block diagram of a video decoder utilizing the perceptual loop filter shown in FIG. 9.

### DETAILED DESCRIPTION

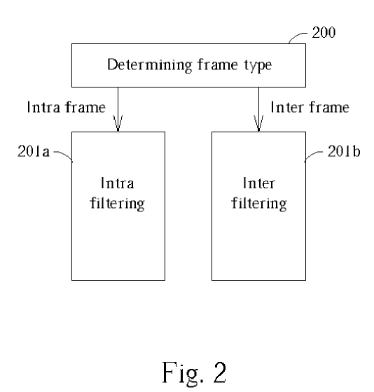

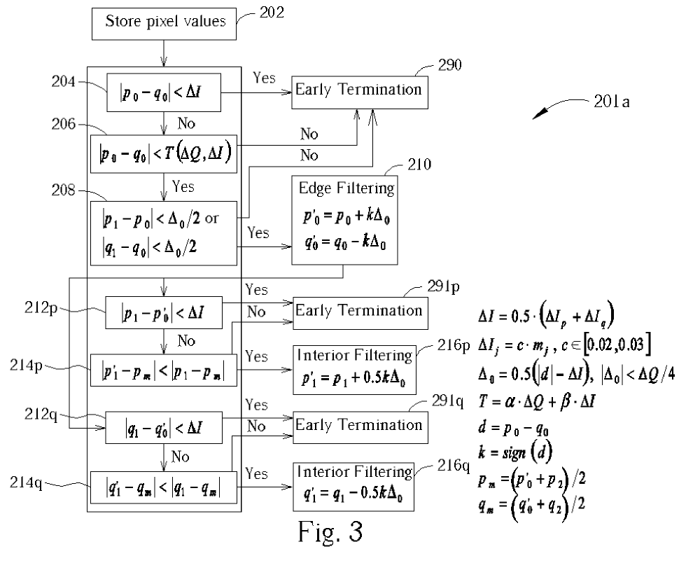

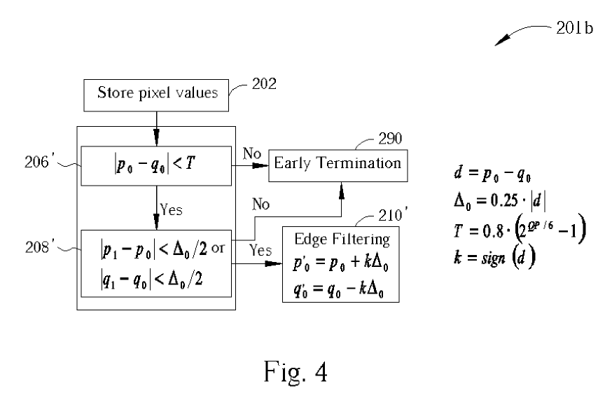

Please refer to FIGS. 2-4. FIG. 2 illustrates a flowchart of a video processing method according to the present invention. FIGS. 3 and 4 respectively illustrate steps 201a and 201b shown in FIG. 2 in detail. At first, step 200 of the present invention method determines the frame type, wherein step 200 is well known in the art. When a frame needing to be processed is an intra frame, step 201a will be executed; else, the frame needing to be processed is an inter frame and step 201b will be executed. The above-mentioned intra frame includes: intra slice and synchronized intra slice (SI slice). The above-mentioned inter frame includes: predicted slice (P slice), bidirectional predicted slice (B slice), and synchronized predicted slice (SP slice). As the content of step 201b is similar to a portion of the content of step 201a, descriptions of step 201b will come after descriptions of step 201a.

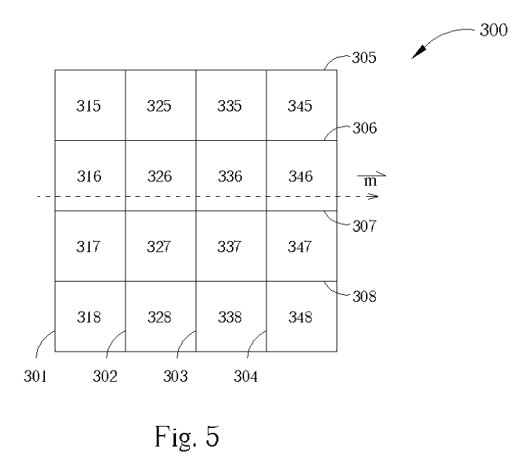

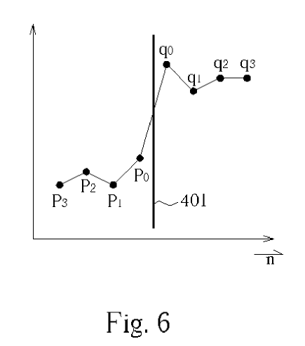

Please refer to FIGS. 3-6. FIG. 5 is a diagram of related blocks processed by the video processing method shown in FIG. 2. FIG. 6 is a pixel sequence diagram with the pixels processed by the video processing method shown in FIG. 2. In the present embodiment, video pictures processed by the method shown in FIG. 3 and FIG. 4 consist of macroblocks 300 shown in FIG. 5. Each macroblock 300 includes sixteen blocks 315, 316, . . . , 348, wherein each block includes 4 by 4 luminance pixel values or 2 by 2 chromatic pixel values. The vertical axis in FIG. 6 denotes the magnitude of the pixel values, and the horizontal axis in FIG. 6 denotes a normal vector n, wherein the normal vector n is perpendicular to a boundary 401 between two adjacent blocks P and Q (not shown) within the video picture.

The pixel values pᵢ and qᵢ (i=0, 1, . . . ) shown in FIGS. 3, 4, and 6 correspond to the two adjacent blocks P and Q, wherein the pixel values p₀ and q₀ denote the pixel values of two boundary edge pixels closest to the boundary 401 between the two blocks P and Q and arranged along the normal vector n. The pixel values p₁ and q₁ denote the pixel values of two interior edge pixels less close to the boundary 401 and arranged along the normal vector n, and so on. For example, assuming that the blocks 326 and 336 shown in FIG. 5 are the two adjacent blocks P and Q, respectively, and the normal vector m shown in FIG. 5 is one of all the normal vectors perpendicular to the boundary 303, then the boundary 401 shown in FIG. 6 is the boundary 303 shown in FIG. 5 and the normal vector n shown in FIG. 6 is the normal vector m shown in FIG. 5. In this situation, the pixel values p₀, p₁, . . . shown in FIG. 6 denote the pixel values of the pixels sequentially arranged away from the boundary 303 and along the normal vector m while the first pixel value p₀ corresponds to the pixel closest to the boundary 303 and within the block 326. Similarly, the pixel values q₀, q₁, . . . shown in FIG. 6 denote the pixel values of the pixels sequentially arranged away from the boundary 303 and along the normal vector m while the first pixel value q₀ corresponds to the pixel closest to the boundary 303 and within the block 336. As the choice of the normal vector m changes, the blocking artifacts on boundaries 301, 302, . . . , 308 of each blocks 315, 316, . . . , 348 of each macroblock 300 within the video picture are processed by the video processing method shown in FIGS. 3 and 4, and all the blocking artifacts are removed.

As illustrated in FIG. 3, the present invention provides the video processing method for processing the blocking artifacts between the two blocks P and Q within the video picture. The video processing method is a loop filtering method of a video encoding process or a video decoding process. The order of the following steps is not a limitation of the present invention. Step 201a of the video processing method is described in detail as follows.

Step 202: Store the pixel values pᵢ and qᵢ (i=0, 1, and 2) corresponding to the two blocks P and Q.

Step 204: Compare the pixel values p₀ and q₀ of the two boundary edge pixels adjacent to the boundary 401 between the two blocks P and Q according to a noticeable difference threshold ΔI to determine if the pixel values p₀ and q₀ of the two boundary edge pixels should be adjusted. If a difference Ip₀−q₀I between the pixel values p₀ and q₀ of the two boundary edge pixels is less than the noticeable difference threshold ΔI, enter the Early Termination state 290 to save time for further processing of other pixel values; else, proceed to step 206. The noticeable difference threshold ΔI is referred to as the just noticeable difference (JND) ΔI.

Step 206: Compare the pixel values p_{0 and q}₀ of the two boundary edge pixels adjacent to the boundary 401 between the two blocks P and Q according to a recognizable discontinuity threshold T(ΔQ, ΔI) to determine if the pixel values p₀ and q₀ of the two boundary edge pixels should be adjusted. If the difference Ip−q₀I between the pixel values p₀ and q₀ of the two boundary edge pixels is less than the recognizable discontinuity threshold T(ΔQ, ΔI), proceed to step 208; else, enter the Early Termination state 290 to save time for further processing of other pixel values. Wherein the recognizable discontinuity threshold T(ΔQ, ΔI) is referred to as the recognizable discontinuity limit T(ΔQ, ΔI).

Step 208: Compare the pixel value p₀ or q₀ corresponding to one pixel out of the two boundary edge pixels with the pixel value p₁ or q₁ corresponding to the interior edge pixel adjacent to the one pixel according to an adjustment threshold Δ₀/2 to determine if the pixel values p₀ and q₀ of the two boundary edge pixels should be adjusted. If either a difference Ip₁−p₀I between the pixel values p₁ and p₀ of the block P is less than the adjustment threshold Δ₀/2 or a difference Iq₁−q₀I between the pixel values q₁ and q₀ of the block Q is less than the adjustment threshold Δ₀/2, proceed to step 210; else, enter the Early Termination state 290 to save time for further processing of other pixel values.

Step 210: Adjust the pixel values p₀ and q₀ of the two boundary edge pixels to decrease the difference Ip₀−q₀I between the pixel values p₀ and q₀ of the two boundary edge pixels. Wherein, the difference Ip₀−q₀I is a luminance difference or a chromatic difference. The adjustment results of this step are listed as follows:
p₀′=p₀+kΔ₀
q₀′=q₀−kΔ₀

and after the adjustment of this step, execute steps 212p and 212q respectively.

Step 212p: Compare an adjusted pixel value p₀′ of an adjusted pixel out of the two boundary edge pixels with the pixel value p₁ of the interior edge pixel adjacent to the adjusted pixel according to the noticeable difference threshold ΔI to determine if the pixel value p₁ of the interior edge pixel should be adjusted. If a difference Ip₁−p₀′I between the pixel values p₁ and p₀′ is less than the noticeable difference threshold ΔI, enter the Early Termination state 291p to save time for further processing of other pixel values; else, proceed to step 214p.

Step 214p: Calculate a predictive adjustment value p₁′ of the interior edge pixel adjacent to the adjusted boundary edge pixel as the following:
p₁′=p₁+0.5kΔ₀

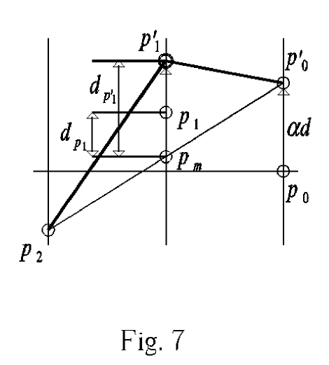

and compare the pixel value p₁ of the interior edge pixel with the predictive adjustment value p₁′ to determine which of the values p₁ or p₁′ is closer to an average pₘ, and to determine if the pixel value p₁ of the interior edge pixel should be adjusted. As illustrated in FIG. 7, the average pₘ is the midpoint between the pixel values p₀′ and p₂. If a difference p₁′−pₘI between the values p₁′ and pₘ is less than a difference Ip₁−pₘI between the values p₁ and pₘ, proceed to step 216p; else, the pixel value p₁ will not be adjusted.

Step 216p: Adjust the pixel value p₁ of the interior edge pixel to be the predictive adjustment value p₁′ thereof (i.e. p₁′=p₁+0.5kΔ₀).

Step 212q: Compare an adjusted pixel value q₀′ of an adjusted pixel out of the two boundary edge pixels with the pixel value q₁ of the interior edge pixel adjacent to the adjusted pixel according to the noticeable difference threshold ΔI to determine if the pixel value q₁ of the interior edge pixel should be adjusted. If a difference Iq₁−q₀′I between the pixel values q₁ and q₀′ is less than the noticeable difference threshold ΔI, enter the Early Termination state 291q to save time for further processing of other pixel values; else, proceed to step 214q.

Step 214q: Calculate a predictive adjustment value q₁′ of the interior edge pixel adjacent to the adjusted boundary edge pixel as the following:
q₁′=q₁−0.5kΔ₀

and compare the pixel value q₁ of the interior edge pixel with the predictive adjustment value q₁′ to determine which of the values q₁ or q₁′ is closer to an average qₘ of the adjusted pixel value q₀′ of the adjusted boundary edge pixel, and to determine if the pixel value q₁ of the interior edge pixel should be adjusted. As illustrated in FIG. 7, the average qₘ is the midpoint between the pixel values q₀′ and q₂. If a difference Iq₁′−qₘI between the values q₁′ and qₘ is less than a difference Iq₁−qₘI between the values q₁ and qₘ, proceed to step 216q; else, the pixel value q₁ will not be adjusted.

Step 216q: Adjust the pixel value q₁ of the interior edge pixel to be the predictive adjustment value q₁′ thereof (i.e. q₁′=q₁−0.5kΔ₀).

The above-mentioned noticeable difference threshold ΔI is defined according to Weber's Law. As Weber's Law describes, the ratio of the increment threshold to the background intensity is a constant k, i.e. the Weber Fraction k. In the present embodiment, the average luminance of the block P can be defined as Iₚ and the average luminance of the block Q can be defined as I_{q}. According to Weber's Law, the ratio of the JND ΔIₚ that the human eye can hardly distinguish to the background luminance Iₚ is equal to the constant k. Similarly, the ratio of the JND ΔI_{q} that the human eye can hardly distinguish to the background luminance I_{q} is equal to the constant k. As illustrated by the parameter list shown in FIG. 3, the noticeable difference threshold ΔI utilized in the present invention method is the average (ΔIₚ+ΔI_{q})/2 of the JNDs ΔIₚ and ΔI_{q} of the two blocks. That is, the noticeable difference threshold ΔI can be derived as the following:
ΔI=(ΔIₚ+ΔI_{q})/2=(kIₚ+kI_{q})/2

As mentioned, the present invention method can be applied to the luminance pixel values pᵢ and qᵢ. In addition, the present invention method can also be applied to the chromatic pixel values pᵢ and qᵢ. When the pixel values pᵢ and qᵢ processed by the present invention method are chromatic pixel values pᵢ and qᵢ, the average chromatic pixel value of the block P can be defined as Iₚ and the average chromatic pixel value of the block Q can be defined as I_{q}. Similarly, the noticeable difference threshold ΔI can be derived as the following:
ΔI=(ΔIₚ+ΔI_{q})/2=(kIₚ+kI_{q})/2

As mentioned in step 216p, the adjustment amount 0.5kΔ₀ of the pixel value p₁ of the interior edge pixel is one half of the adjustment amount kΔ₀ of the pixel value p₀ of the adjusted boundary edge pixel. In addition, as mentioned in step 216q, the adjustment amount −0.5kΔ₀ of the pixel value q₁ of the interior edge pixel is one half of the adjustment amount −kΔ₀ of the pixel value q₀ of the adjusted boundary edge pixel. Please note, the parameter list shown in FIG. 3 illustrates that the recognizable discontinuity threshold T(ΔQ, ΔI) is defined as the linear combination (αΔQ+αΔI) of the noticeable difference threshold ΔI and the difference ΔQ between the quantization parameters of the two blocks P and Q. Wherein, the simplest parameter set α=β=1 can be applied to the present embodiment, although this is not a limitation of the present invention. In another embodiment of the present invention, the recognizable discontinuity threshold T(ΔQ, ΔI) can be a higher order polynomial of (ΔQ, ΔI) or other kinds of functions of (ΔQ, ΔI) as long as the following conditions are satisfied: firstly, when the difference ΔQ between two quantization parameters of the two blocks P and Q increases or the noticeable difference threshold ΔI increases, the recognizable discontinuity threshold T(ΔQ, ΔI) increases correspondingly; and secondly, when the difference ΔQ decreases or the noticeable difference threshold ΔI decreases, the recognizable discontinuity threshold T(ΔQ, ΔI) decreases correspondingly. Therefore, the present invention method further includes: when the difference ΔQ between two quantization parameters of the two blocks P and Q increases or the noticeable difference threshold ΔI increases, increasing the recognizable discontinuity threshold T(ΔQ, ΔI); and when the difference ΔQ decreases or the noticeable difference threshold ΔI decreases, decreasing the recognizable discontinuity threshold T(ΔQ, ΔI).

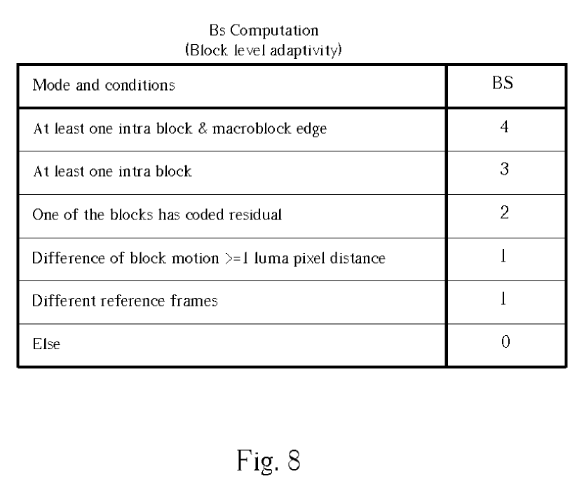

Please refer to FIGS. 2, 4, and 8. FIG. 8 is a lookup table of the boundary strength (BS) used in the inter filtering process shown in FIG. 4, wherein the BS, which is defined in the JVT (H.264) specification, is well known in the art. As illustrated in FIG. 2, when the frame needing to be processed is an inter frame, step 201b will be executed. First, the present invention method checks if the BS of the frame needing to be processed according to the lookup table shown in FIG. 8 is zero. If the BS is zero, execute step 201b according to the detailed steps shown in FIG. 4; else, the frame needing to be processed will not be renewed. As shown in FIG. 4, step 201b of the video processing method is described in detail as follows.

Step 202: Store the pixel values pᵢ and qᵢ (i=0, 1, and 2) corresponding to the two blocks P and Q.

Step 206′: Compare the pixel values p₀ and q₀ of the two boundary edge pixels adjacent to the boundary 401 between the two blocks P and Q according to a threshold T to determine if the pixel values p₀ and q₀ of the two boundary edge pixels should be adjusted. If the difference Ip₀−q₀I between the pixel values p₀ and q₀ of the two boundary edge pixels is less than the threshold T, proceed to step 208′; else, enter the Early Termination state 290 to save time for further processing of other pixel values. Wherein the threshold T of this step is defined as the parameter list shown in FIG. 4.

Step 208′: Compare the pixel value p₀ or q₀ corresponding to one pixel out of the two boundary edge pixels with the pixel value p₁ or q₁ corresponding to the interior edge pixel adjacent to the one pixel according to an adjustment threshold Δ₀/2 to determine if the pixel values p₀ and q₀ of the two boundary edge pixels should be adjusted. If either a difference Ip₁−p₀I between the pixel values p₁ and p₀ of the block P is less than the adjustment threshold Δ₀/2 or a difference Iq₁−q₀I between the pixel values q₁ and q₀ of the block Q is less than the adjustment threshold Δ₀/2, proceed to step 210′; else, enter the Early Termination state 290 to save time for further processing of other pixel values. Wherein the parameter Δ₀/2 is defined as the parameter list shown in FIG. 4 and therefore, the definition of the adjustment threshold Δ₀/2 of this step is changed accordingly.

Step 210′: Adjust the pixel values p₀ and q₀ of the two boundary edge pixels to decrease the difference Ip₀−q₀I between the pixel values p₀ and q₀ of the two boundary edge pixels. Wherein the difference Ip₀−q₀I is a luminance difference or a chromatic difference. The adjustment results of this step are listed as follows:
p₀′=p₀+kΔ₀
q₀′=q₀−kΔ₀

wherein the parameter Δ₀/2 is defined as the parameter list shown in FIG. 4 and therefore, the adjustment results of this step are changed accordingly.

In this embodiment, when an average of the quantization parameters of the two blocks P and Q is less than sixteen, the blocking artifacts of the boundary 401 between the two blocks P and Q will not be processed so as to save time for further processing of the blocking artifacts of other boundaries of the video picture.

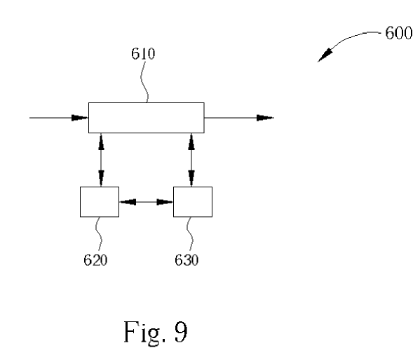

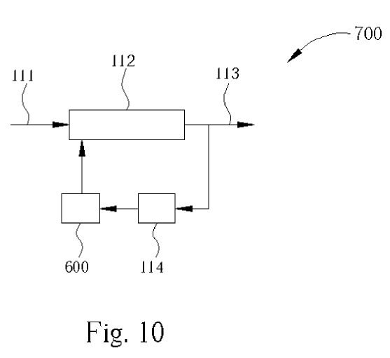

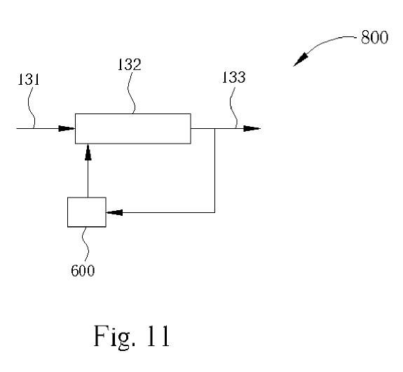

Please refer to FIGS. 9-11. FIG. 9 is a block diagram of a perceptual loop filter 600 according to the present invention. FIGS. 10 and 11 respectively illustrate video processing systems 700 and 800 utilizing the perceptual loop filter 600 shown in FIG. 9. While providing the above-mentioned method, the present invention correspondingly provides a loop filter 600 of a video processing system for processing the blocking artifacts between the two blocks P and Q within the video picture, wherein the video processing system can be a video encoder 700 or a video decoder 800. As the above-mentioned method utilizes the recognizable discontinuity threshold T(ΔQ, ΔI) and the noticeable difference threshold ΔI related to whether the human eye can distinguish the blocking artifacts or not, the loop filter 600 is referred to as the Perceptual Loop Filter (PLF) 600. The loop filter 600 includes: a storage unit 610 for storing the pixel values pᵢ and qᵢ corresponding to the two blocks P and Q; and a comparison unit 620 electrically connected to the storage unit 610 for comparing the two pixel values p₀ and q₀ of the two boundary edge pixels adjacent to the boundary 401 between the two blocks P and Q according to the noticeable difference threshold ΔI to determine if the pixel values p₀ and q₀ of the two boundary edge pixels should be adjusted. If the difference Ip₀−q₀1 between the pixel values p₀ and q₀ of the two boundary edge pixels is less than the noticeable difference threshold ΔI, the comparison unit 620, as described in step 204, enters the Early Termination state 290 to save time for further processing of other pixel values; else, as described in step 206, the comparison unit 620 compares the pixel values p₀ and q₀ of the two boundary edge pixels adjacent to the boundary 401 between the two blocks P and Q according to the recognizable discontinuity threshold T(ΔQ, ΔI) to determine if the pixel values p₀ and q₀ of the two boundary edge pixels should be adjusted. If the difference Ip₀−q₀I between the pixel values p₀ and q₀ of the two boundary edge pixels is less than the recognizable discontinuity threshold T(ΔQ, ΔI), the comparison unit 620 further performs the comparison as described in 208; else, the comparison unit 620 enters the Early Termination status 290 to save time for further processing of other pixel values. As mentioned, the pixel values p₀ and q₀ can be either the luminance pixel values p₀ and q₀ or the chromatic pixel values p₀ and q₀, and accordingly, the difference Ip₀−q₀I can be either the luminance difference or the chromatic difference.

The loop filter 600 further includes an arithmetic unit 630 electrically connected to the comparison unit 620 and the storage unit 610 for adjusting the pixel values pᵢ and qᵢ of the two boundary edge pixels. As described in step 208, the comparison unit 620 further compares the pixel values p₀ and q₀ (corresponding to one pixel out of the two boundary edge pixels) with the pixel values p₁ and q₁ (corresponding to the interior edge pixel adjacent to the one pixel), respectively, according to an adjustment threshold Δ₀/2 to determine if the pixel values p₀ and q₀ of the two boundary edge pixels should be adjusted. If either the difference Ip₁−p₀I between the pixel values p₁ and p₀ of the block P is less than the adjustment threshold Δ₀/2 or the difference q₁−q₀I between the pixel values q₁ and q₀ of the block Q is less than the adjustment threshold Δ₀/2, the comparison unit 620 determines that the pixel values p₀ and q₀ of the two boundary edge pixels should be adjusted as described in step 210 using the arithmetic unit 630 to decrease the difference Ip₀−q₀I between the pixel values p₀ and q₀. The comparison unit 620 may further execute steps 212p and 214p to determine if the pixel value p₁ of the interior edge pixel should be adjusted to be the predictive adjustment value p₁′ thereof (i.e. p₁′=p₁+0.5kΔ₀) as described in step 216p using the arithmetic unit 630. As mentioned above, the adjustment amount 0.5kΔ₀ of the pixel value p₁ of the interior edge pixel is one half of the adjustment amount kΔ₀ of the pixel value p₀ of the adjusted boundary edge pixel mentioned in step 210. Similarly, the comparison unit 620 may further execute steps 212q and 214q to determine if the pixel value q₁ of the interior edge pixel should be adjusted to be the predictive adjustment value q₁′ thereof (i.e. q₁′=q₁−0.5kΔ₀) as described in step 216q using the arithmetic unit 630. Again, as mentioned above, the adjustment amount −0.5kΔ₀ of the pixel value q₁ of the interior edge pixel is one half of the adjustment amount −kΔ₀ of the pixel value q₀ of the adjusted boundary edge pixel mentioned in step 210.

In this embodiment, when the difference ΔQ between two quantization parameters of the two blocks P and Q increases or the noticeable difference threshold ΔI increases, the comparison unit 620 increases the recognizable discontinuity threshold T(ΔQ, ΔI). In addition, when the difference ΔQ decreases or the noticeable difference threshold ΔI decreases, the comparison unit 620 decreases the recognizable discontinuity threshold T(ΔQ, ΔI).

As in the above-mentioned method, the execution of steps 206′, 208′, and 210′ by the components according to this embodiment is similar to the execution of steps 206, 208, and 210, respectively, with the above-mentioned exception of the choices of the threshold T and the parameter Δ₀. Therefore, the descriptions of the execution of steps 206′, 208′, and 210′ will not be repeated.

Normally, in a quantization operation of video processing, as the quantization parameters of all blocks within an image increase, the quality of the image becomes lower. Conversely, as the quantization parameters decrease, the quality of the image becomes higher. The quantization parameter range corresponding to better image quality is around twenty-two and below. With the range of the quantization parameters being around twenty-two and below, the present invention method and apparatus provide equivalent image quality with the loop filters complying with the H.264 specification in the art.

It is an advantage of the present invention that the present invention method and device process the blocking artifacts of the video picture by loop filtering so that the present invention method and device have better processing efficiency in contrast to post filtering methods and devices.

It is another advantage of the present invention that the present invention method and device use perceptual thresholds to determine if the pixel values of the two boundary edge pixels should be adjusted so that fast determination and ignoring of blocking artifacts that are not easy to identify by the human eye is available. As a result, the early termination of processing according to the fast determination enhances the processing efficiency of the video picture.

It is another advantage of the present invention that the calculations of the present invention method and device are simple. Because the video picture consists of blocks arranged in two directions, i.e. the vertical direction and the horizontal direction, only pixel value(s) of up to two pixels located at one side of each block boundary and along a normal direction perpendicular to the boundary need to be adjusted. Therefore, the processing efficiency of the present invention method and device is better than that of the prior art methods and devices complying with the H.264 specification.

Those skilled in the art will readily observe that numerous modifications and alterations of the device may be made while retaining the teachings of the invention. Accordingly, the above disclosure should be construed as limited only by the metes and bounds of the appended claims.

1. A video processing method for processing blocking artifacts between two blocks within a video picture, the video processing method comprising:
storing pixel values corresponding to the two blocks; and
comparing two boundary edge pixels adjacent to a boundary between the two blocks according to a first threshold to determine if the pixel values of the two boundary edge pixels should be adjusted, if a difference corresponding to the pixel values of the two boundary edge pixels meets a requirement of the first threshold, adjusting the pixel values of the two boundary edge pixels to decrease the difference.

2. The video processing method of claim 1, wherein the difference is a luminance difference or a chromatic difference.

3. The video processing method of claim 1 further comprising:
comparing one pixel out of the two boundary edge pixels with an interior edge pixel adjacent to the one pixel according to a second threshold to determine if the pixel values of the two boundary edge pixels should be adjusted.

4. The video processing method of claim 3 further comprising:
comparing an adjusted pixel out of the two boundary edge pixels with an interior edge pixel adjacent to the adjusted pixel according to a third threshold to determine if the pixel value of the interior edge pixel should be adjusted.

5. The video processing method of claim 4, wherein the third threshold is equal to the first threshold.

6. The video processing method of claim 4, wherein an adjustment amount of the pixel value of the interior edge pixel is one half of an adjustment amount of the pixel value of the adjusted boundary edge pixel.

7. The video processing method of claim 1 further comprising:
when a difference between two quantization parameters of the two blocks increases, increasing the first threshold; and
when the difference between the two quantization parameters decreases, decreasing the first threshold.

8. The video processing method of claim 1 further comprising:
when a just noticeable difference defined according to Weber's Law increases, increasing the first threshold; and
when the just noticeable difference decreases, decreasing the first threshold.

9. The video processing method of claim 1, wherein the first threshold is a just noticeable difference defined according to Weber's Law.

10. The video processing method of claim 1 being a loop filtering method of a video encoding process or a video decoding process.

11. A loop filter of a video processing system for processing blocking artifacts between two blocks within a video picture, the loop filter comprising:
a storage unit for storing pixel values corresponding to the two blocks;
a comparison unit electrically connected to the storage unit for comparing two boundary edge pixels adjacent to a boundary between the two blocks according to a first threshold to determine if the pixel values of the two boundary edge pixels should be adjusted, if a difference corresponding to the pixel values of the two boundary edge pixels meets a requirement of the first threshold, the comparison unit determining that the pixel values of the two boundary edge pixels should be adjusted to decrease the difference; and
an arithmetic unit electrically connected to the comparison unit and the storage unit for adjusting the pixel values of the two boundary edge pixels.

12. The loop filter of claim 11, wherein the difference is a luminance difference or a chromatic difference.

13. The loop filter of claim 11, wherein the comparison unit further compares one pixel out of the two boundary edge pixels with an interior edge pixel adjacent to the one pixel according to a second threshold to determine if the pixel values of the two boundary edge pixels should be adjusted.

14. The loop filter of claim 13, wherein the comparison unit further compares an adjusted pixel out of the two boundary edge pixels with an interior edge pixel adjacent to the adjusted pixel according to a third threshold to determine if the pixel value of the interior edge pixel should be adjusted.

15. The loop filter of claim 14, wherein the third threshold is equal to the first threshold.

16. The loop filter of claim 14, wherein an adjustment amount of the pixel value of the interior edge pixel is one half of an adjustment amount of the pixel value of the adjusted boundary edge pixel.

17. The loop filter of claim 11, wherein when a difference between two quantization parameters of the two blocks increases, the comparison unit increases the first threshold; and when the difference between the two quantization parameters decreases, the comparison unit decreases the first threshold.

18. The loop filter of claim 11, wherein when a just noticeable difference defined according to Weber's Law increases, the comparison unit increases the first threshold; and when the just noticeable difference decreases, the comparison unit decreases the first threshold.

19. The loop filter of claim 11, wherein the first threshold is a just noticeable difference defined according to Weber's Law.

20. The loop filter of claim 11, wherein the video processing system is a video encoder or a video decoder.
